(19) United States
(12) Patent Application Publication
(10) Pub. No.: US 2015/0207376 A1
(43) Pub. Date: Jul. 23, 2015

(54) ELECTRIC MACHINE AND MOTOR VEHICLE WITH SUCH AN ELECTRIC MACHINE

(71) Applicant: AUDI AG, 85045 Ingolstadt (DE)

(72) Inventor: Mario Wildgruber, Rohrbach (DE)

(73) Assignee: AUDI AG, 85045 Ingolstadt (DE)

(21) Appl. No.: 14/416,002

(22) PCT Filed: Jun. 21, 2013
(86) PCT No.: PCT/EP2013/001839

§ 371 Date: Jan. 20, 2015

(30) Foreign Application Priority Data
Jul. 21, 2012 (DE) 10 2012 014 453.9

(51) Int. Cl. H02K 5/14; H02K 13/10; H02K 11/00

(52) U.S. Cl. CPC H02K 5/14; H02K 11/0073; H02K 13/10

(57) ABSTRACT

An electric machine includes a housing, a controller for influencing an excitation current for the electric machine, and a carrier, formed separately to the controller, for carbon brushes resting on slip rings of a rotor shaft of the electric machine. The housing has on an outer side (7) a plurality of pairs of mutually associated electric contact points for the carrier to enable the carrier to be attached to one of several different positions, independent of the position of the controller.

The invention relates to an electric machine having a housing, a controller for influencing an excitation current for the electric machine, and a carrier configured separately formed from the controller and provided for carbon brushes which rest upon slip rings of a rotor shaft of the electric machine.

Motor vehicles have separately excited electric machines used as generator to supply electric power for the on-board electrical system and to sufficiently charge the battery as energy storage. Conventional electric machines include a controller which is formed as an integrated circuit (IC) and transmits a variable excitation current to an excitation winding of the generator. The excitation current is dependent on the on-board electrical system load and the actual rotation speed of the electric machine. Transmission to the excitation winding is realized via carbon brushes which rest upon slip rings of a rotor shaft, a separately-excited synchronous machine is involved. The controller controls the voltage induced in the windings and thus the power output.

It is known to use as generator electric machines in which the carbon brushes are integrated together with the IC-controller in a single structure. A disadvantage, however, is hereby that the entire module, which also includes the controller, has to be replaced, when the carbon brushes need to be replaced as a result of wear.

It has therefore already been proposed to provide the IC-controller with a separate housing and to attach a carrier for the carbon brushes separately onto the generator housing.

The limited installation space for the electric machine frequently causes space problems because of the large variety of models and the number of motors being offered. To avoid the need for production of expensive tools, the carbon brushes are installed partially suspended, i.e. they are situated below the rotor shaft. Still, when exposed to water, suspended carbon brushes encounter the risk of water entering the slip ring space or flowing into the carbon brush well to potentially cause subsequent failure of the generator and a vehicle defect. To avoid this drawback, there is a need to reconstruct the housing of the electric machine or its rear bearing plate, thereby increasing costs.

The invention is therefore based on the object to provide an electric machine in which the position of the carbon brushes can be selected in a flexible manner in dependence on the available installation space.

This object is achieved with an electric machine of the afore-mentioned type by providing in accordance with the invention an outer side of the housing with several pairs of mutually associated electric contact points for the carrier, which enable attachment of the carrier to one of several different positions irrespective of the position of the controller.

The invention is based on the recognition that the carrier for the carbon brushes can be rotated to an optimal “standing” position or secured in this position, so long as respectively appropriate electric contact points are provided. These contact points enable an adjustment of the attachment position of the carrier for the carbon brushes in dependence on the installation conditions at hand. Since several pairs of possible contact points are provided, an installation situation can be modified in the absence of any constructional changes to the outer side of the housing or a bearing plate of the electric machine.

An even better adjustment to different installation situations is realized by arranging the pairs of mutually associated contact points on circles or circle segments. Since the carbon brushes, which are held in the carrier, touch with their free ends the rotor shaft, the pairs of the contact points can be arranged on circles or circle segments, which are arranged about the rotation axis of the rotor shaft.

Preferably, the contact points can be arranged on two concentric circles or circle segments, with a first contact point being arranged on a first circle or first circle segment, and with a second contact point being arranged on a second circle or a second circle segment.

It is also within the scope of the invention to configure the circles or circle segments as conductor paths. In this variant, the carrier may be arranged at any position along the conductor path, i.e., there are no defined contact points. As an alternative or in addition, it is also possible to provide fixed contact points which, preferably, can be arranged at fixed angular distances.

To facilitate installation of the carrier, the electric machine according to the invention can be provided with mechanical fasteners at at least one attachment position for the carrier. The mechanical fasteners permit easy and quick securement of the carrier to the housing or a bearing plate, with electric contact preferably being automatically established when being secured. The electric contact points for the carrier are connected to the controller via lines or conductor paths which are arranged on or in the housing. The controller has the integrated circuit (IC) which governs the required excitation current, in addition the controller establishes the communication with other components of the on-board electrical system.

The mentioned mechanical fasteners can be configured on the outer side of the housing or on the bearing plate as internal threads into which screw fasteners for the carrier can be threadably engaged or are threadably engaged. A carrier can thus be easily mounted by a screw fastener to the housing or a bearing plate. The use of an internal thread is to be understood merely by way of example, as an alternative, it is, of course, also possible to provide a bolt having an outer thread or contact points that enable a securement of the carrier by soldering or welding.

According to an alternative configuration of the electric machine according to the invention, the mechanical fasteners are formed as plug connections⁻ which can be locked or are locked with plug connections of the carrier.

It is also within the scope of the invention to arrange the carrier of the electric machine according to the invention on the housing in such a way that the carbon brushes are arranged in the installed state at level with the rotor shaft or above it. As a result of this standing attachment, ingress of water or dirt into the carrier is substantially avoided, thereby realizing a high reliability in operation.

Preferably, the electric machine is designed as a generator for a motor vehicle.

In addition, the invention relates to a motor vehicle. The motor vehicle according to the invention is characterized in that it includes at least an electric machine of the type described.

Further advantages and details of the invention will be readily apparent hereinafter using an exemplary embodiment with reference to the drawings. The drawings are schematic illustrations and show:

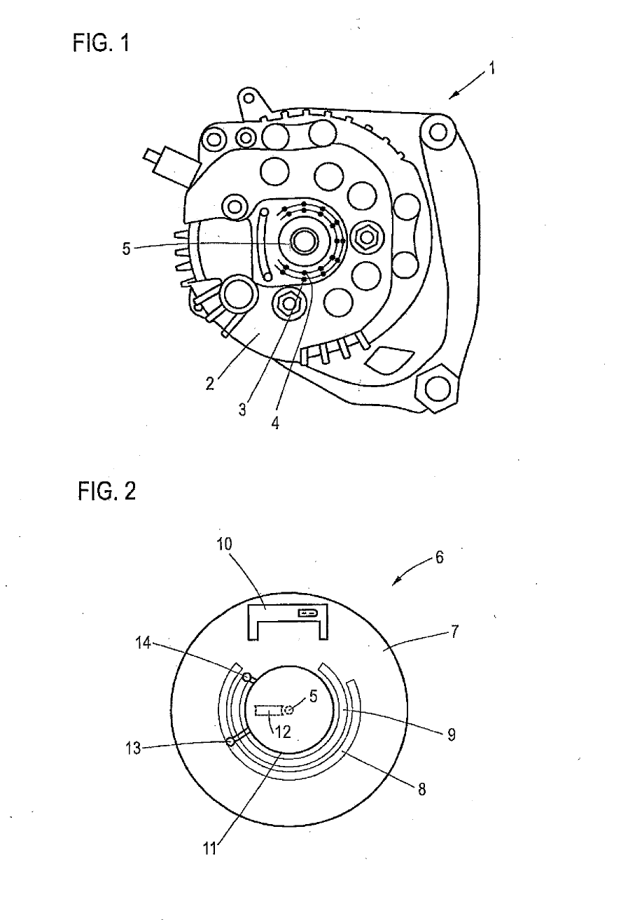

FIG. 1 a side view of an electric machine according to the invention;

FIG. 2 a basic representation of an exemplary embodiment of an electric machine according to the invention;

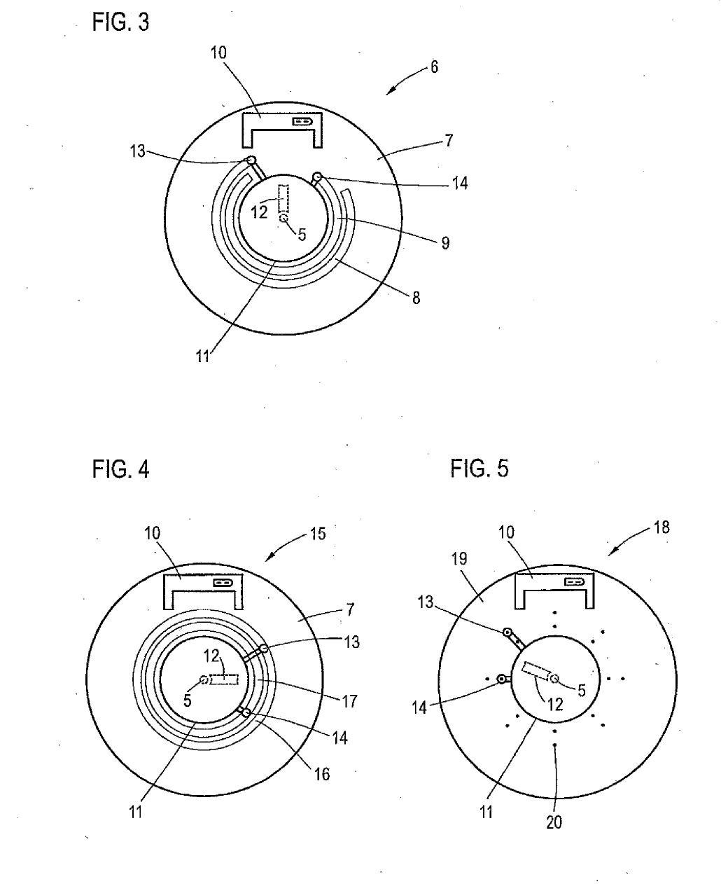

FIG. 3 the electric machine shown in FIG. 2 with a carrier for carbon brushes being mounted on another position;

FIG. 4 another exemplary embodiment of an electric machine according to the invention; and

FIG. 5 a further exemplary embodiment of an electric machine according to the invention.

FIG. 1 is a side view of an electric machine 1 which is configured as a generator of a motor vehicle. Arranged on the outer side of the housing 2 are several pairs of mutually associated electric contact points 3, 4. FIG. 1 shows that both the outer contact points 3 and the inner contact points 4 are arranged on a circular segment-shaped path. For ease of illustration, the contact points 3, 4 are merely shown as circles, each contact point may, however, also be designed as internal thread or have an internal thread. Two associated contact points 3, 4 are electrically insulated from each other.

A carrier (not shown) is attached at the contact points 3, 4 and has the two carbon brushes which rest radially upon the rotor shaft 5 of the electric machine 1. The rotor shaft 5 has slip rings to supply in this way the excitation windings of the electric machine 1 with the required excitation current.

For sake of clarity, the controller is not shown in FIG. 1 and is always mounted at the same location.

FIG. 2 shows schematically a side view of a second exemplary embodiment of an electric machine 6 having an outer side 7 on which conductor paths 8, 9 are arranged. The conductor paths 8, 9 are configured as concentric circle segments with several attachment points. The conductor paths 8, 9 are connected via conductor paths, not shown in greater detail, with a controller 10 which is also arranged on the outer side 7 of the electric machine 6. The controller 10 has an integrated circuit which influences the controller current and assumes the communication with other components of the on-board electric system.

A carrier 11, which accommodates the carbon brushes 12, is mounted to the outer side 7 in such a way that its contacts 13, 14 touch the first conductor path 8 and the second conductor path 9, respectively. The conductor paths 8, 9 are connected via not shown line connections to the controller 10. The carrier 11 can be mounted over a wide angular range in different angular positions, irrespective of the fixed controller 10. Depending on a particular installation position, an optimal position can be found for the carrier 11 in each case, with the carbon brushes 12 being arranged such that the risk of contamination is minimized. In the exemplary embodiment shown in FIG. 2, the carbon brushes 12 assume a horizontal position.

FIG. 3 shows the electric machine 6 of FIG. 2, with the carrier 11 being mounted in a different position. In FIG. 3, the carrier 11 is arranged such that the carbon brushes 12 extend vertical, thus no water can penetrate into the carbon well in the carrier 11. As the contacts 13, 14 touch the conductor paths 8, 9, there is also here a connection between the carbon brushes 12 via the conductor paths 8, 9 to the controller 10.

FIG. 4 shows a further exemplary embodiment of an electric machine 15, in which the conductor paths 16, 17 are formed as circles. This configuration has the advantage that the carrier 11 can be infinitely positioned in any position.

FIG. 5 shows another exemplary embodiment of an electric machine 18 having an outer side 19 on which contact points 20 are arranged. The contact points 20 are respectively spaced from one another by 45° so as to establish a total of eight different mounting options for the carrier 11. The individual contact points 20 are formed as internal thread or blind holes, so that the carrier 11 can be threadably engaged with its contacts 13, 14 with the contact points 20.

What is claimed is:

1-10. (canceled)

11. An electric machine, comprising:
a housing having an outer side provided with several pairs of mutually associated electric contact points;
a controller configured to influence an excitation current for the electric machine; and
a carrier formed separately from the controller and provided for carbon brushes which rest upon slip rings of a rotor shaft of the electric machine, said carrier being selectively attachable to the pairs of contact points to enable attachment of the carrier at one of several distinct mounting positions, irrespective of a position of the controller.

12. The electric machine of claim 11, wherein the, pairs of contact points are arranged on circles or circle segments.

13. The electric machine of claim 12, wherein the pairs of contact points are arranged on two concentric circles or circle segments.

14. The electric machine of claim 12, wherein the circles or circle segments are configured as conductor paths.

15. The electric machine of claim 11, further comprising mechanical fasteners arranged at at least one mounting position for the carrier.

16. The electric machine of claim 15, wherein the mechanical fasteners are configured as internal thread arranged in the housing for threaded engagement of fastening screws for the carrier.

17. The electric machine of claim 15, wherein the mechanical fasteners are configured as plug connections for locking with plug connections of the carrier.

18. The electric machine of claim 11, wherein the carrier is arranged on the housing such that the carbon brushes, when installed, are arranged at level with the rotor shaft or above it.

19. The electric machine of claim 11, constructed in the form of a generator, motor, or fan motor for a motor vehicle.

20. A motor vehicle, comprising at least an electric machine which includes a housing having an outer side provided with several pairs of mutually associated electric contact points, a controller configured to influence an excitation current for the electric machine, and a carrier formed separately from the controller and provided for carbon brushes which rest upon slip rings of a rotor shaft of the electric machine, said carrier being selectively attachable to the pairs of contact points to enable attachment of the carrier at one of several distinct mounting positions, irrespective of a position of the controller.

21. The motor vehicle of claim 20, wherein the pairs of contact points are arranged on circles or circle segments.

22. The motor vehicle of claim 21, wherein the pairs of contact points are arranged on two concentric circles or circle segments.

23. The motor vehicle of claim 21, wherein the circles or circle segments are configured as conductor paths.

24. The motor vehicle of claim 20, wherein the electric machine includes mechanical fasteners arranged at at least one mounting position for the carrier.

25. The motor vehicle of claim 24, wherein the mechanical fasteners are configured as internal thread arranged in the housing for threaded engagement of fastening screws for the carrier.

26. The motor vehicle of claim 24, wherein the mechanical fasteners are configured as plug connections for locking with plug connections of the carrier.

27. The motor vehicle of claim 20, wherein, the carrier is arranged on the housing such that the carbon brushes, when installed, arranged at level with the rotor shaft or above it.

28. The motor vehicle of claim 20, wherein the electric machine is constructed in the form of a generator, motor, or fan motor for the motor vehicle.
